(19) United States
(12) Patent Application Publication
(10) Pub. No.: US 2014/0239724 A1
(43) Pub. Date: Aug. 28, 2014

(54) POWER CONDITIONER AND POWER CONDITIONING METHOD

(71) Applicant: TAKASAGO, LTD., Kanagawa (JP)

(72) Inventors: Yasuhiro ISHIKAWA, Kanagawa (JP); Kazuaki HONDA, Kanagawa (JP)

(73) Assignee: TAKASAGO, LTD., Kanagawa (JP)

(21) Appl. No.: 14/082,964

(22) Filed: Nov. 18, 2013

(30) Foreign Application Priority Data
Feb. 22, 2013 (JP) 2013-033783

(51) Int. Cl. H02M 7/537; H02J 5/00

(52) U.S. Cl. CPC H02M 7/537; H02J 5/00
USPC 307/66; 363/97; 363/56.01

(57) ABSTRACT

A power conditioner according to an exemplary aspect of the present invention includes a first converter that converts a first DC voltage supplied from an external power supply into a second DC voltage, an inverter that converts the second DC voltage into an AC voltage and outputs the AC voltage to an external line so as to keep receiving power by the external line from a supply source system in a predetermined range, and an energy management unit that stops operations of the first converter and the inverter at predetermined time previously determined based on a magnitude of load power consumed by a load connected to the external line.

### INCORPORATION BY REFERENCE

This application is based upon and claims the benefit of priority from Japanese patent application No. 2013-033783, filed on Feb. 22, 2013, the disclosure of which is incorporated herein in its entirety by reference.

### BACKGROUND OF THE INVENTION

1. Technical Field

The present invention relates to a power conditioner and a power conditioning method, and particularly to a load following type power conditioner and power conditioning method.

2. Background Art

In recent years, photovoltaic systems including rechargeable batteries have been widespread. In such a photovoltaic system, electric power generated by photovoltaic panels (solar panels) can be charged to the rechargeable batteries. Then, DC (Direct Current) voltages generated by the solar panels and DC voltages discharged from the rechargeable batteries are converted into AC (Alternate Current) voltages by a power conditioner, i.e., Power Conditioning System (PCS), and supplied to loads. This reduces the amount of electric power received and purchased from the supply source system.

Incidentally, Japanese Unexamined Patent Application Publication No. 2006-84373 discloses a power conditioner having a load following function that conditions an amount of electric power discharged from rechargeable batteries according to load fluctuations. Such a load following function reduces the amount of electric power purchased from the supply source system while achieving load balancing, thereby enabling so-called peak shaving.

### SUMMARY

The present inventor has found a following problem. For example, almost all loads (air conditioner, television, hot water heater, lighting equipment, etc.) stop operations at midnight, and only standby power of the loads is consumed. The power conditioner (PCS) disclosed in Japanese Unexamined Patent Application Publication No. 2006-84373 is considered to maintain the load following function even when the power consumption (load power) of such loads is small. Here, when the load power is small, the power consumption of the power conditioner itself will become relatively large. As a result, there has been a problem such as increasing the amount of electric power purchased from the supply source system or consuming electricity of the rechargeable batteries for maintaining the load following function in maintaining the load following function even when the load power is small.

The present invention is made in view of the above technical background, and an object thereof is to provide a power conditioner with reduced power consumption.

An exemplary aspect of the present invention is a power conditioner that includes a first converter that converts a first DC voltage supplied from an external power supply into a second DC voltage; an inverter that converts the second DC voltage into an AC voltage and outputs the AC voltage to an external line so as to keep receiving power received by the external line from a supply source system in a predetermined range; and an energy management unit that stops operations of the first converter and the inverter at predetermined time previously determined based on a magnitude of load power consumed by a load connected to the external line.

It is thus possible to provide the power conditioner with reduced power consumption by stopping the operations of the first converter and the inverter at the predetermined time previously determined based on the magnitude of the load power.

Another exemplary aspect of the present invention is a power conditioner that includes a first converter that converts a first DC voltage supplied from an external power supply into a second DC voltage; an inverter that converts the second DC voltage into an AC voltage and outputs the AC voltage to an external line so as to keep receiving power received by the external line from a supply source system in a predetermined range; and an energy management unit that stops operations of the first converter and the inverter when load power consumed by a load connected to the external line falls below a predetermined threshold.

It is thus possible to provide the power conditioner with reduced power consumption by stopping the operations of the first converter and the inverter when the load power falls below a predetermined threshold.

An exemplary aspect of the present invention is a method of conditioning power for a power conditioner including a first converter that converts a first DC voltage supplied from an external power supply into a second DC voltage and an inverter that converts the second DC voltage into an AC voltage and outputs the AC voltage to an external line. The method includes operating the inverter so as to keep receiving power received by the external line from a supply source system in a predetermined range; and stopping operations of the first converter and the inverter at predetermined time previously determined based on a magnitude of load power consumed by a load connected to the external line

It is thus possible to reduce power consumption by stopping the operations of the first converter and the inverter at the predetermined time previously determined based on the magnitude of the load power

Another exemplary aspect of the present invention is a method of conditioning power for a power conditioner including a first converter that converts a first DC voltage supplied from an external power supply into a second DC voltage and an inverter that converts the second DC voltage into an AC voltage and outputs the AC voltage to an external line. The method includes operating the inverter so as to keep receiving power received by the external line from a supply source system in a predetermined range; and stopping operations of the first converter and the inverter when load power consumed by a load connected to the external line falls below a predetermined threshold.

It is thus possible to reduce power consumption by stopping the operations of the first converter and the inverter when the load power falls below a predetermined threshold.

According to the present invention, it is possible to provide the power conditioner with reduced power consumption.

### BRIEF DESCRIPTION OF THE DRAWINGS

The above and other aspects, features, and advantages of the present invention will become more apparent from the following description of certain exemplary embodiments when taken in conjunction with the accompanying drawings, in which:

FIG. 1 is a block diagram showing a configuration example of a power receiving system to which a power conditioner according to a first exemplary embodiment is applied;

FIG. 2 is a block diagram showing a configuration example of the power conditioner PCS according to the first exemplary embodiment;

FIG. 3 is a sequence diagram for explaining an activation method from a dormant state in the power conditioner PCS according to the first exemplary embodiment;

FIG. 4 is a block diagram showing a configuration example of a power conditioner PCS according to a modified example of the first exemplary embodiment;

FIG. 5 is a block diagram showing a configuration example of a power conditioner PCS according to a second exemplary embodiment;

FIG. 6 is a graph showing a relationship between adjusting power Pc, which is output from the power conditioner PCS according to the second exemplary embodiment, and load power P_{L}; and

FIG. 7 is a block diagram showing a configuration example of a power conditioner PCS according to a modified example of the second exemplary embodiment.

### EXEMPLARY EMBODIMENTS

Hereinafter, specific exemplary embodiments to which the present invention is applied are explained in detail with reference to the drawings. However, the present invention is not necessarily limited to the following exemplary embodiments. Moreover, for clarity of the explanation, the following description and drawings are simplified as appropriate.

### First Exemplary Embodiment

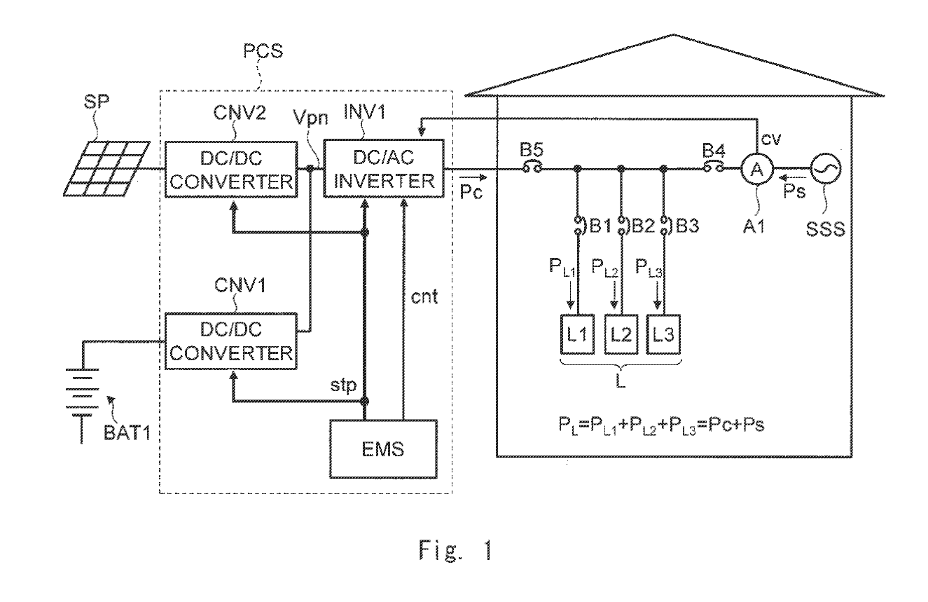

First, a power receiving system to which the power conditioner according to a first exemplary embodiment can be applied is explained with reference to FIG. 1. FIG. 1 is a block diagram showing a configuration example of the power receiving system to which the power conditioner according to the first exemplary embodiment is applied.

As shown in FIG. 1, the power receiving system according to the first exemplary embodiment includes a solar panel SP, a main battery BAT1, a power conditioner PCS, three loads L1 to L3, five breakers B1 to B5, an ammeter A1, and a supply source system SSS. Here, the power conditioner PCS includes two DC/DC converters CNV1 and CNV2, a DC/AC inverter INV1, and an energy management unit EMS. The number of loads and breakers is merely an example.

The solar panel SP is made of polycrystalline silicon, monocrystalline silicon, a compound semiconductor and the like, for example. The solar panel SP converts light energy from sunlight into electric energy using the photovoltaic effect. Then, the solar panel SP outputs the generated DC voltage (i.e., DC power) to the DC/DC converter CNV2.

The main battery (external power supply) BAT1 is composed of a rechargeable battery such as a lithium ion battery, lead-acid battery, nickel-cadmium battery, nickel-hydride battery, sodium-sulfur battery, and flywheel battery. The main battery BAT1 outputs a DC voltage (i.e., DC power) to the DC/DC converter CNV2.

Meanwhile, the main battery BAT1 can charge the electricity generated by the solar panel SP through the DC/DC converter CNV1 and the DC/DC converter CNV2. Alternatively, the main battery BAT1 can charge the electricity supplied from the supply source system SSS through the DC/AC inverter INV1 and the DC/DC converter CNV2. Note that the main battery BAT1 is not limited to the rechargeable battery but may be, for example, a fuel cell that does not require charge.

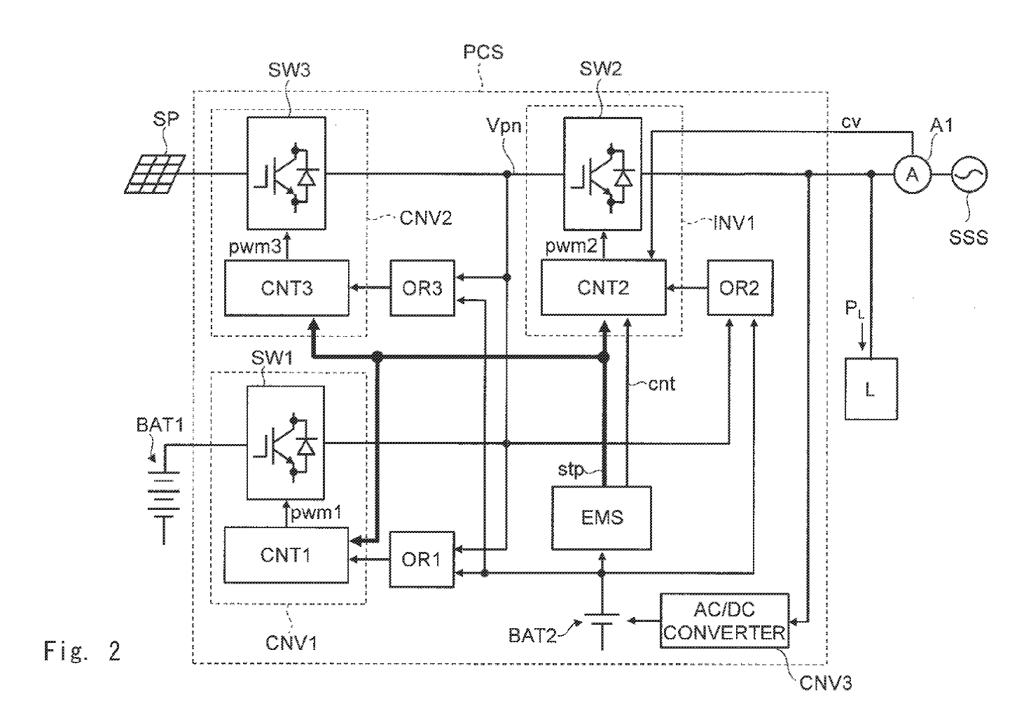

The DC/DC converter (first converter) CNV1 boosts or reduces the DC voltage input from the main battery BAT1 to a DC voltage Vpn and outputs the DC voltage Vpn to the DC/AC inverter INV1. The details of the DC/DC converter CNV1 are described later using FIG. 2.

The DC/DC converter (second converter) CNV2 boosts or reduces the DC voltage input from the solar panel SP to the DC voltage Vpn and outputs the DC voltage Vpn to the DC/AC inverter INV1. The details of the DC/DC converter CNV2 are described later using FIG. 2.

The DC/AC inverter INV1 converts the DC voltage Vpn input from the DC/DC converter CNV1 and the DC/DC converter CNV2 into an AC voltage and supplies the AC voltage to the loads L1 to L3. That is, the DC powers output from the DC/DC converters CNV1 and CNV2 are converted into AC power by the DC/AC inverter INV1. Based on a control signal cnt output from the energy management unit EMS, the DC/AC inverter INV1 generates and outputs conditioning power Pc so as to keep receiving power Ps from the supply source system SSS constant (i.e., keep the receiving power Ps in a predetermined range). That is, the control signal cnt instructs the DC/AC inverter INV1 to keep the receiving power Ps from the supply source system SSS constant.

A current value cv, which is supplied to the loads L1 to L3 from the supply source system SSS, is fed back to the DC/AC inverter INV1. The DC/AC inverter INV1 calculates the receiving power Ps from the fed-back current value cv. Then, the DC/AC inverter INV1 generates and outputs the conditioning power Pc to keep the receiving power Ps constant. With such a configuration, it is possible to keep the receiving power Ps at a constant value (0 W, for example) even when there are fluctuations in the load power P_{L} that is consumed by the loads L1 to L3. Namely, the power conditioner PCS has a load following function. The details of the DC/AC inverter INV1 are described later using FIG. 2.

The energy management unit EMS outputs the control signal cnt for keeping the receiving power Ps at a predetermined value to the DC/AC inverter INV1.

The energy management unit EMS further outputs a stop signal stp to the DC/DC converters CNV1 and CNV2 and the DC/AC inverter INV1. The energy management unit EMS has a scheduling function (scheduler) and activates the stop signal stp at predetermined time when the load power P_{L} consumed by the loads L1 to L3 is small. When the stop signal stp is activated, the operations of the DC/DC converters CNV1 and CNV2 and the DC/AC inverter INV1 are stopped.

As mentioned above, the power conditioner PCS according to this exemplary embodiment stops the operations of the DC/DC converters CNV1 and CNV2 and the DC/AC inverter INV1 and suspends the load following operation at predetermined time when the load power P_{L} is small. Therefore, the power conditioner PCS according to this exemplary embodiment can effectively reduce the power consumption of the power conditioner PCS itself.

The schedule of the load following operation can be configured as appropriate to the energy management unit EMS according to a user's life pattern, for example. Further, the energy management unit EMS may continue monitoring the receiving power Ps even during suspension of the load following operation (receiving power Ps=load power P_{L}, because the conditioning power Pc=0) and statistically process the state of electric power consumption, so as to automatically update the schedule as needed (at weekly interval, for example).

The loads L1 to L3 compose a load L. The load power P_{L} by the loads L1 to L3 is a sum of load power P_{L} 1 by the load L1, load power P_{L} 2 by the load L1, and load power P_{L} 3 by the load L1. That is, P_{L}=P_{L} 1+P_{L} 2+P_{L} 3 is satisfied. Further, the load power P_{L} by the loads L1 to L3 is a sum of the receiving power Ps supplied from the supply source system SSS and the conditioning power Pc supplied from the power conditioner PCS. That is, P_{L}=Ps+Pc is satisfied.

The breaker B1 is a molded case circuit breaker for preventing an overcurrent from flowing into a line connected to the load L1. Similarly, the breaker B2 is a molded case circuit breaker for preventing an overcurrent from flowing into a line connected to the load L2. Similarly, the breaker B3 is a molded case circuit breaker for preventing an overcurrent from flowing into a line connected to the load L3.

The breaker B4 is a power receiving circuit breaker for interrupting the electric power from the supply source system SSS. Meanwhile, the breaker B5 is a power receiving circuit breaker for interrupting the electric power from the power conditioner PCS.

The ammeter A1 detects a receiving current from the supply source system SSS. The value of the receiving power Ps that is necessary for the load following operation can be calculated from the current value cv measured by the ammeter A1. It is obvious that in place of the ammeter A1, a power meter may be provided to directly measure the value of the receiving power Ps which is fed back to the DC/AC inverter INV1.

Next, the details of the power conditioner PCS are explained with reference to FIG. 2. FIG. 2 is a block diagram showing a configuration example of the power conditioner PCS according to the first exemplary embodiment. As shown in FIG. 2, in addition to the two DC/DC converters CNV1 and CNV2, the DC/AC inverter INV1, and the energy management unit EMS shown in FIG. 1, the power conditioner PCS includes three OR circuits OR1 to OR3, an AC/DC converter CNV3, and an auxiliary battery BAT2. In other words, the three OR circuits OR1 to OR3, the AC/DC converter CNV3, and the auxiliary battery BAT2 are not shown in FIG. 1.

Here, as shown in FIG. 2, the DC/DC converter CNV1 includes a controller CNT1 and a switching circuit SW1. The DC/AC inverter INV1 includes a controller CNT2 and a switching circuit SW2. The DC/DC converter CNV2 includes a controller CNT3 and a switching circuit SW3.

First, the DC/DC converter CNV1 is explained.

The controller CNT1 outputs a PWM (Pulse Width Modulation) control signal pwm1 to the switching circuit SW1. As a voltage for the controller CNT1 to operate, an output voltage of the auxiliary battery BAT2 or the input voltage Vpn to the DC/AC inverter INV1 (i.e., output voltages of the DC/DC converters CNV1 and CNV2) of the DC/AC inverter INV1 is supplied through the OR circuit OR1.

The switching circuit SW1 includes a transistor and a diode which are switching elements. The transistor repeats ON and OFF at a pulse width corresponding to the PWM control signal pwm1 input to a control terminal. Such a switching operation of the switching circuit SW1 enables the DC/DC converter CNV1 to convert the DC voltage output from the main battery BAT1 into a predetermined DC voltage. Note that the kind of the transistor as the switching element is not limited in particular. Moreover, it is not limited to the transistor as long as a switching function is included.

Next, the DC/DC converter CNV2 is explained.

The controller CNT3 outputs a PWM control signal pwm3 to the switching circuit SW3. As a voltage for the controller CNT3 to operate, the output voltage of the auxiliary battery BAT2 or the input voltage Vpn to the DC/AC inverter INV1 is supplied through the OR circuit OR3.

The switching circuit SW3 includes a transistor and a diode which are switching elements. The transistor repeats ON and OFF at a pulse width corresponding to the PWM control signal pwm3 input to a control terminal. Such a switching operation of the switching circuit SW3 enables the DC/DC converter CNV2 to convert the DC voltage output from the solar panel SP into a predetermined DC voltage.

Next, the DC/AC inverter INV1 is explained.

The controller CNT2 generates a PWM control signal pwm2 so as to keep the receiving power Ps from the supply source system SSS constant based on the control signal cnt output from the energy management unit EMS and the current value cv supplied from the supply source system SSS to the load L (corresponding to the loads L1 to L3 in FIG. 1). This PWM control signal pwm2 is input to the switching circuit SW2. As a voltage for the controller CNT2 to operate, the output voltage of the auxiliary battery BAT2 or the input voltage Vpn to the DC/AC inverter INV1 is supplied through the OR circuit OR2.

The switching circuit SW2 includes a transistor and a diode which are switching elements. The transistor repeats ON and OFF at a pulse width corresponding to the PWM control signal pwm2 input to a control terminal. Such a switching operation of the switching circuit SW2 enables the DC/AC inverter INV2 to convert the DC voltages output from the DC/DC converter CNV1 and the DC/DC converter CNV2 into a predetermined AC voltage.

Moreover, in the DC/AC inverter INV1, the current value cv, which is supplied from the supply source system SSS to the load L, is fed back to the controller CNT2. Therefore, the controller CNT2 can keep the receiving power Ps at a constant value (0 W, for example) even when there are fluctuations in the load power P_{L} by controlling the conditioning power Pc that is output from the switching circuit SW2 (i.e., the conditioning power Pc output from the power conditioner PCS). Here, the controller CNT2 can calculate the receiving power Ps from the current value cv.

All of the OR circuits OR1 to OR3 select and output one of the output voltage of the auxiliary battery BAT2 and the input voltage Vpn of the DC/AC inverter INV1 according to an operation state of the power conditioner PCS. The OR circuits OR1 to OR3 can be composed of a diode and a switch, for example.

Note that a control method of the switching circuits SW1 to SW3 is not limited to PWM control, and other pulse modulation method can be used. In addition, the main battery BAT1 may also be input to each of the OR circuits OR1 to OR3, so that the OR circuits OR1 to OR3 have three inputs. Alternatively, each of the OR circuits OR1 to OR3 may remain with two inputs, one of which being the main battery BAT1 in place of the auxiliary battery BAT2.

The energy management unit EMS outputs the control signal cnt for keeping the receiving power Ps at a predetermined value to the controller CNT2 of the DC/AC inverter INV1. A voltage for the energy management unit EMS to operate is supplied from the auxiliary battery BAT2.

Here, the auxiliary battery BAT2 is a similar battery to the main battery BAT1. The auxiliary battery BAT2 can charge the electricity supplied from the supply source system SSS through the AC/DC converter CNV3. Note that the auxiliary battery BAT2 may be charged by the main battery BAT1 and the input voltage Vpn of the DC/AC inverter INV1 in place of the above-mentioned supply source system SSS.

Also note that a configuration may be employed in which the controller CNT2 previously stores the control signal cnt for keeping the receiving power Ps at a predetermined value in place of the configuration in which the energy management unit EMS outputs the control signal cnt to the controller CNT of the DC/AC inverter INV1.

Further, the energy management unit EMS outputs the stop signal stp to the controllers CNT1 to CNT3. The energy management unit EMS has the scheduling function and activates the stop signal stp at predetermined time when the load power P_{L} is small. When the stop signal stp is activated, the operations of the controllers CNT1 to CNT3 are stopped. For example, when the stop signal stp is activated, the OR circuits OR1 to OR3 stop supplying operating voltages to the controllers CNT1 to CNT3, thereby stopping the operations of the controllers CNT1 to CNT3.

When the operations of the controllers CNT1 to CNT3 are stopped, output of the PWM control signals pwm1 to pwm3 is also stopped. Thus, the operations of the switching circuits SW1 to SW3 are stopped as well. Note that the energy management unit EMS may stop only the operations of the switching circuits SW1 to SW3 without stopping the operations of the controllers CNT1 to CNT3.

As described above, the power receiving system according to this exemplary embodiment stops the operations of the switching circuits SW1 to SW3 in the DC/DC converter CNV1, the DC/AC inverter INV1, and the DC/DC converter CNV2, respectively, at predetermined time when the load power P_{L} is small. Further, the operations of the controllers CNT1 to CNT3 are also stopped. It is preferable to stop the operations of the controllers CNT1 to CNT3 by interrupting the supply of the operating voltages to the controllers, as described above.

Thus, in the power conditioner PCS according to this exemplary embodiment, the operations of the switching circuits are stopped at predetermined time when the load power P_{L} is small, thereby effectively reducing the power consumption of the power conditioner PCS itself.

Moreover, in the power conditioner PCS according to this exemplary embodiment, the operations of the controllers for controlling the switching circuits are also stopped. It is thus possible to further effectively reduce the power consumption of the power conditioner PCS itself.

Additionally, when the supply of the operating voltages to the controllers is interrupted to stop the operation of the controllers, there will be no standby power generated by the controllers. That is, it is possible to highly effectively reduce the power consumption of the power conditioner PCS itself. At the time to be activated by the scheduler, the power conditioner PCS is activated and resumes the load following operation regardless of the magnitude of the load power P_{L}.

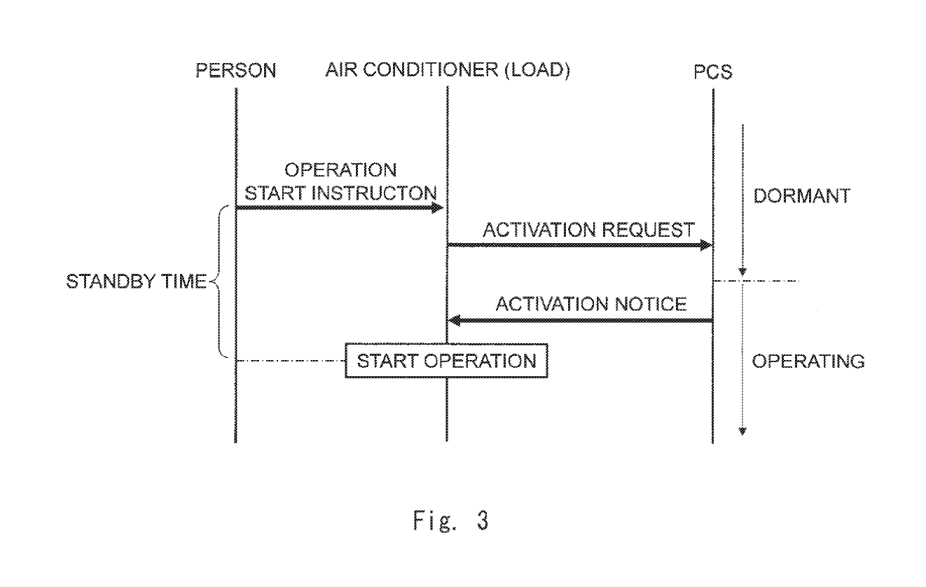

Next, an activation method from a dormant state in the power conditioner PCS is explained with reference to FIG. 3. FIG. 3 is a sequence diagram for explaining the activation method from the dormant state in the power conditioner PCS. As described above, when the operations of the DC/DC converter CNV1, the DC/AC inverter INV1, and the DC/DC converter CNV2 are stopped, the power conditioner PCS stops the load following operation and transitions to the dormant state. In the power conditioner PCS according to this exemplary embodiment, when the load L is used in the dormant state, the power conditioner PCS is activated and the load following operation is resumed.

The example of FIG. 3 assumes the case in which an air conditioner (which corresponds to one of the loads L1 to L3 in FIG. 1, for example) is turned on.

First, a person instructs the air conditioner (load) to start an operation. Specifically, the person operates a remote control to turn on the air conditioner, for example.

Next, when the air conditioner (load) detects the instruction to start the operation by the person, the air conditioner (load) transmits an activation request to the energy management unit EMS of the power conditioner PCS.

The energy management unit EMS of the power conditioner PCS receives the activation request from the air conditioner (load), and then the energy management unit EMS activates the DC/DC converter CNV1, the DC/AC inverter INV1, and the DC/DC converter CNV2. Specifically, the energy management unit EMS activates the controllers CNT1 to CNT3 shown in FIG. 2 (by deactivating the stop signal stp shown in FIGS. 1 and 2, for example). Subsequently, the energy management unit EMS transmits an activation notice to the air conditioner (load).

Then, the air conditioner (load) receives the activation notice from the energy management unit EMS of the power conditioner PCS and starts the operation.

As described above, when the instruction to start the operation is made to the load during suspension of the power conditioner PCS, the load starts the operation after the power conditioner PCS is activated. Therefore, standby time is generated between the instruction to start the operation and the actual operation start. However, the receiving power Ps from the supply source system SSS can be reduced.

Note that the communication method between the air conditioner (load) and the power conditioner PCS is not limited in particular. For example, the communication method may be wireless communication compliant with ZigBee standard, for example, and wired communication such as PLC (Power Line Communication). Moreover, since the power consumption of the load can be predicted, it is possible to configure the energy management unit EMS whether or not to activate the power conditioner PCS for each of the loads to be used. That is, the energy management unit EMS can be configured not to activate the power conditioner PCS when the power consumption of the load to be used is small. Note that the configuration may be set either to inside or outside (the load L, for example) of the power conditioner PCS.

### Modified Example of the First Exemplary Embodiment

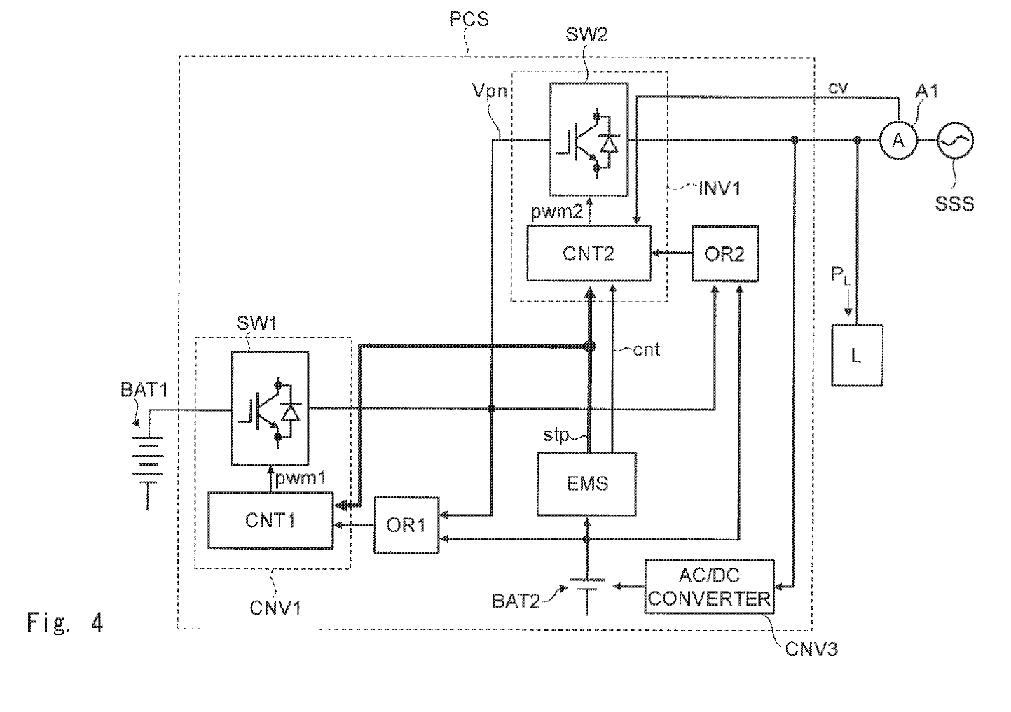

Next, a power conditioner according to a modified example of the first exemplary embodiment is explained with reference to FIG. 4. FIG. 4 is a block diagram showing a configuration example of the power conditioner PCS according to the modified example of the first exemplary embodiment. As shown in FIG. 4, the power conditioner PCS according to the modified example of the first exemplary embodiment does not include the DC/DC converter CNV2 and the OR circuit OR3, which are included in the power conditioner PCS shown in FIG. 2. That is, the power receiving system to which the power conditioner PCS according to the modified example of the first exemplary embodiment is applied does not include the solar panel SP. As other configuration is same as in FIG. 2, the explanation shall not be provided here.

In the power conditioner PCS according to the modified example of the first exemplary embodiment, the operations of the switching circuits SW1 and SW2 in the DC/DC converter CNV1 and the DC/AC inverter INV1, respectively, are stopped at predetermined time when the load power P_{L} is small. The operations of the controller CNT1 and CNT2 are also stopped. It is preferable to stop the operations of the controller CNT1 and CNT2 by interrupting supply of the operating voltages to the controllers.

Thus, in the power conditioner PCS according to the modified example of the first exemplary embodiment, the operations of the switching circuits are stopped at predetermined time when the load power P_{L} is small, thereby effectively reducing the power consumption of the power conditioner PCS itself.

Moreover, in the power conditioner PCS according to the modified example of the first exemplary embodiment, the operations of the controllers for controlling the switching circuits are also stopped, thereby further effectively reducing the power consumption of the power conditioner PCS itself.

Additionally, when the supply of the operating voltages to the controllers is interrupted to stop the operation of the controllers, there will be no standby power generated by the controllers. That is, it is possible to highly effectively reduce the power consumption of the power conditioner PCS itself.

At the time to be activated by the scheduler, the power conditioner PCS is activated and resumes the load following operation regardless of the magnitude of the load power P_{L}.

### Second Exemplary Embodiment

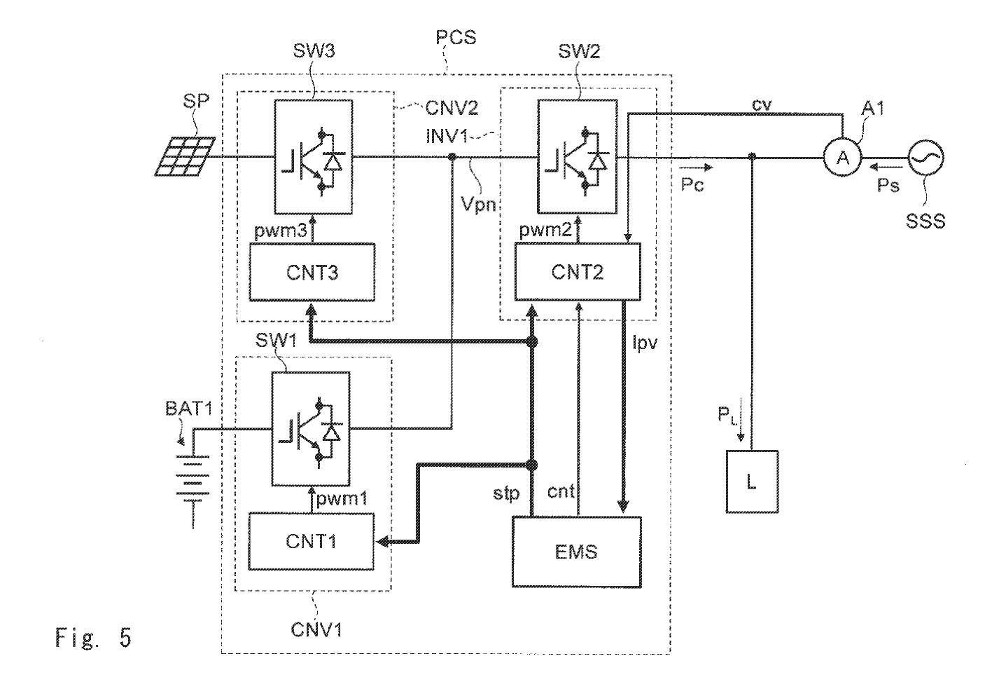

Next, a power conditioner according to a second exemplary embodiment is explained with reference to FIG. 5. FIG. 5 is a block diagram showing a configuration example of the power conditioner PCS according to the second exemplary embodiment. As shown in FIG. 5, in a similar manner to the first exemplary embodiment, the power conditioner PCS includes two DC/DC converters CNV1 and CNV2, the DC/AC inverter INV1, and the energy management unit EMS. Note that FIG. 5 does not illustrate the three OR circuits OR1 to OR3, the AC/DC converter CNV3, and the auxiliary battery BAT2, which are shown in FIG. 2 according to the first exemplary embodiment.

In the power conditioner PCS according to the first exemplary embodiment, the energy management unit EMS has the scheduling function and stops the operations of the DC/DC converters CNV1 and CNV2 and the DC/AC inverter INV1 at predetermined time when the load power P_{L} is small. Meanwhile, in the power conditioner PCS according to the second exemplary embodiment, the energy management unit EMS monitors the load power P_{L} and when the load power P_{L} falls below a predetermined reference value, the power conditioner PCS stops the operations of the DC/DC converters CNV1 and CNV2 and the DC/AC inverter INV1.

Here, in a similar manner to the first exemplary embodiment, in the DC/AC inverter INV1, the current value cv, which is supplied from the supply source system SSS to the load L, is fed back to the controller CNT2, and the load following operation is performed. Therefore, the controller CNT2 can calculate the receiving power Ps from the current value cv. The controller CNT2 also recognizes the value of the conditioning power Pc to be output by the controller CNT2 itself. As described above, the load power P_{L} can be calculated by P_{L}=Ps+Pc. Then, the controller CNT2 calculates the value of the load power P_{L} and notifies the energy management unit EMS of the value of the load power P_{L} as a load power value 1 pv.

Note that obviously, the energy management unit EMS may calculate the value of the load power P_{L} in place of the controller CNT2 of the DC/AC inverter INV1. Further, in place of calculating the value of the load power P_{L}, an ammeter and a power meter may be provided to each of the lines to which the loads L1 to L3 shown in FIG. 1 are connected so as to directly measure the load power P_{L} 1, P_{L} 2, and P_{L} 3. However, it is more preferable that the power conditioner PCS calculates the value of the load power P_{L} from the receiving power Ps used for the load following operation and the conditioning power Pc output by the power conditioner PCS, because it is not necessary to further provide the ammeter and the power meter.

The energy management unit EMS outputs the control signal cnt for keeping the receiving power Ps at a predetermined value to the controller CNT2 of the DC/AC inverter INV1. Moreover, when the value of the load power P_{L} (load power value 1 pv) received from the controller CNT2 falls below threshold power Pth, the energy management unit EMS activates the stop signal stp to be output to the controllers CNT1 to CNT3. Then, the operations of the controllers CNT1 to CNT3 are stopped. For example, when the stop signal stp is activated, the supply of the operating voltages to the controllers CNT1 to CNT3 is also stopped, thereby stopping the operations of the controllers CNT1 to CNT3.

When the operations of the controllers CNT1 to CNT3 are stopped, output of the PWM control signals pwm1 to pwm3 is also stopped. Thus, the operations of the switching circuits SW1 to SW3 are stopped as well.

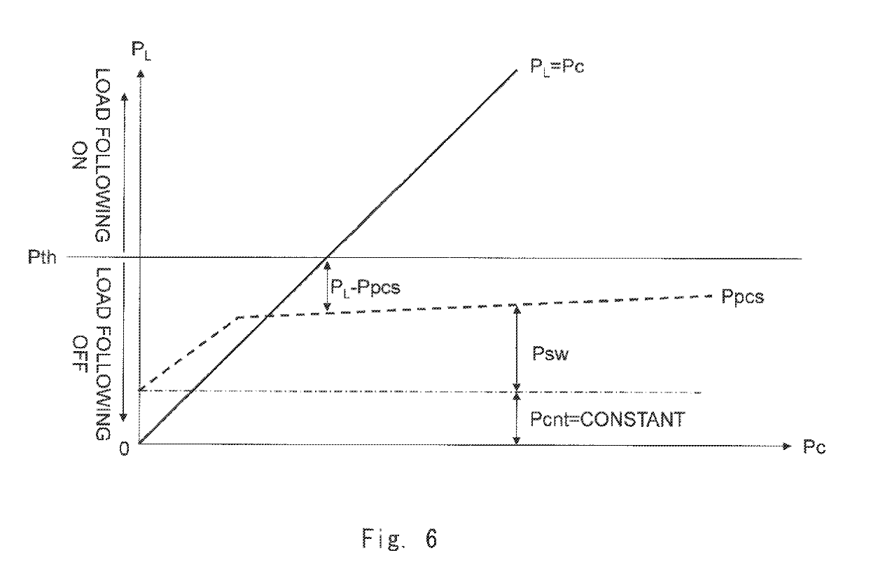

Note that the energy management unit EMS may stop only the operations of the switching circuits SW1 to SW3 without stopping the operations of the controllers CNT1 to CNT3. The details of the determination method of the threshold power Pth are described later with reference to FIG. 6.

Thus, in the power receiving system according to this exemplary embodiment, when the value of the load power P_{L} falls below the predetermined threshold power Pth, the operations of the switching circuits SW1 to SW3 in the DC/DC converter CNV1, the DC/AC inverter INV1, and the DC/DC converter CNV2, respectively, are stopped. Further, the operations of the controllers CNT1 to CNT3 are also stopped. It is preferable to stop the operations of the controllers CNT1 to CNT3 by interrupting the supply of the operating voltages to the controllers, as described above.

Thus, in the power conditioner PCS according to this exemplary embodiment, the operations of the switching circuits are stopped at predetermined time when the value of the load power P_{L} falls below the predetermined threshold power Pth, thereby effectively reducing the power consumption of the power conditioner PCS itself.

Moreover, in the power conditioner PCS according to this exemplary embodiment, the operations of the controllers for controlling the switching circuits are also stopped, thereby further effectively reducing the power consumption of the power conditioner PCS itself.

Additionally, when the supply of the operating voltages to the controllers is interrupted to stop the operation of the controllers, there will be no standby power generated by the controllers. That is, it is possible to highly effectively reduce the power consumption of the power conditioner PCS itself.

Next, the determination method of the threshold power Pth is explained with reference to FIG. 6. FIG. 6 is a graph showing a relationship between the conditioning power Pc output from the power conditioner PCS and the load power P_{L}. The horizontal axis represents the conditioning power Pc, and the vertical axis represents the load power P_{L}. FIG. 6 shows power consumption Ppcs of the power conditioner PCS itself in addition to the load power P_{L}. The solid line indicates the load power P_{L}, and the dashed line indicates the power consumption Ppcs. The example of FIG. 6 shows the case in which the load following operation is performed to maintain the receiving power Ps at 0 W. Therefore, P_{L}=Pc is satisfied between the conditioning power Pc and the load power P_{L}.

As shown in FIG. 6, the power consumption Ppcs of the power conditioner PCS is composed of power consumption Pcnt of the controllers CNT1 to CNT3, and power consumption Psw of the switching circuits SW1 to SW3. As shown in FIG. 6, the power consumption Pcnt of the controllers CNT1 to CNT3 is almost constant regardless of the conditioning power Pc. On the other hand, the conditioning power Pc sharply increases at the stage when the conditioning power Pc is small and gradually increases after that.

The threshold power Pth for evaluating whether or not to perform the load following operation may be determined in consideration of a difference, a ratio and the like between the load power P_{L} and the power consumption Ppcs of the power conditioner PCS. For example, when the load power P_{L} falls below the power consumption Ppcs of the power conditioner PCS, it is clearly preferable to stop the operations of the power conditioner PCS. The example of FIG. 6 sets the threshold power Pth to a point where a difference between the load power P_{L} and the power consumption Ppcs of the power conditioner PCS (the difference is calculated by P_{L}-Ppcs) reaches a predetermined positive value.

In addition, as shown in FIG. 6, the smaller the load power P_{L}, the greater the proportion of the power consumption Pcnt of the controllers to the power consumption Ppcs of the power conditioner PCS. Therefore, the smaller the load power P_{L}, the greater the power reduction effect achieved by stopping the operations of the controllers CNT1 to CNT3. Note that when the load power P_{L} exceeds the threshold power Pth, the power conditioner PCS is activated and resumes the load following operation.

### Modified Example of the Second Exemplary Embodiment

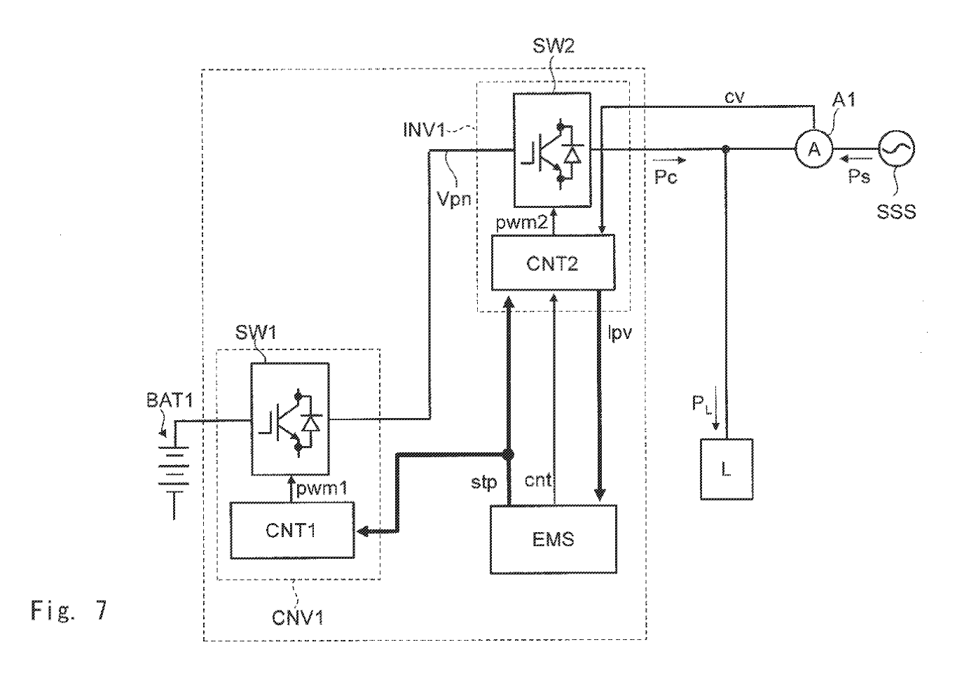

Next, a power conditioner according to a modified example of the second exemplary embodiment is explained with reference to FIG. 7. FIG. 7 is a block diagram showing a configuration example of the power conditioner PCS according to the modified example of the second exemplary embodiment. As shown in FIG. 7, the power conditioner PCS according to the modified example of the second exemplary embodiment does not include the DC/DC converter CNV2, which is included in the power conditioner PCS shown in FIG. 5. That is, the power receiving system to which the power conditioner PCS according to the modified example of the second exemplary embodiment is applied does not include the solar panel SP. As other configuration is same as FIG. 5, the explanation shall not be provided here.

In the power receiving system according to the modified example of the second exemplary embodiment, when the value of the load power P_{L} falls below the predetermined threshold power Pth, the operations of the switching circuits SW1 and SW2 in the DC/DC converter CNV1 and the DC/AC inverter INV1, respectively, are stopped. Further, the operations of the controllers CNT1 and CNT2 are also stopped. It is preferable to stop the operations of the controllers CNT1 and CNT2 by interrupting the supply of the operating voltages to the controllers.

Thus, in the power conditioner PCS according to the modified example of the second exemplary embodiment, the operations of the switching circuits are stopped when the value of the load power P_{L} falls below the predetermined threshold power Pth, thereby effectively reducing the power consumption of the power conditioner PCS.

Moreover, in the power conditioner PCS according to the modified example of the second exemplary embodiment, the operations of the controllers for controlling the switching circuits are also stopped, thereby further effectively reducing the power consumption of the power conditioner PCS.

Additionally, when the supply of the operating voltages to the controllers is interrupted to stop the operation of the controllers, there will be no standby power generated by the controllers. That is, it is possible to highly effectively reduce the power consumption of the power conditioner PCS itself. Note that when the load power P_{L} exceeds the threshold power Pth, the power conditioner PCS is activated and resumes the load following operation.

Although the present invention made by the present inventor has been explained in detail based on the exemplary embodiments, it is obvious that the present invention is not limited to the above-explained exemplary embodiments but various modifications can be made without departing from the scope of the present invention.

For example, in the above exemplary embodiments, the voltage generated by the solar panel SP is supplied to the DC/DC converter CNV2. However, power generation means that supplies the voltage to the DC/DC converter CNV2 is not limited to the solar panel, but other power generation means using natural energy such as wind power generation can also be applied.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A power conditioner comprising:
a first converter that converts a first DC voltage supplied from an external power supply into a second DC voltage;
an inverter that converts the second DC voltage into an AC voltage and outputs the AC voltage to an external line so as to keep receiving power in a predetermined range, the receiving power being received by the external line from a supply source system; and
an energy management unit that stops operations of the first converter and the inverter at predetermined time, the predetermined time being previously determined based on a magnitude of load power consumed by a load connected to the external line.

2. A power conditioner comprising:
a first converter that converts a first DC voltage supplied from an external power supply into a second DC voltage;
an inverter that converts the second DC voltage into an AC voltage and outputs the AC voltage to an external line so as to keep receiving power in a predetermined range, the receiving power being received by the external line from a supply source system; and
an energy management unit that stops operations of the first converter and the inverter when load power consumed by a load connected to the external line falls below a predetermined threshold.

3. The power conditioner according to claim 2, wherein the load power is calculated based on conditioning power output from the inverter and the receiving power.

4. The power conditioner according to claim 1, wherein
the first converter includes a first switching circuit and a first controller,
the inverter includes a second switching circuit and a second controller,
the energy management unit stops the operations of the first converter and the inverter by interrupting supply of an operating voltage to the first controller and the second controller.

5. The power conditioner according to claim 1, wherein
when the energy management unit receives an activation request from a device composing the load while the operations of the first converter and the inverter are stopped, the energy management unit activates the first converter and the inverter while transmitting an activation notice to the device.

6. The power conditioner according to claim 1, further comprising a second converter that converts a third DC voltage into the second DC voltage and outputs the second DC voltage to the inverter, the third DC voltage being supplied from a power generation apparatus using natural energy,
wherein the energy management unit stops an operation of the second converter when the energy management unit stops the operations of the first converter and the inverter.

7. The power conditioner according to claim 6, wherein the power generation apparatus using the natural energy is a power generation apparatus using a solar panel.

8. The power conditioner according to claim 6, wherein
the second converter includes a third switching circuit and a third controller, and
the energy management unit stops the operation of the second converter by interrupting supply of an operating voltage to the third controller.

9. The power conditioner according to claim 1, wherein a value of the receiving power is calculated from a measurement value of a receiving current supplied from the supply source system.

10. The power conditioner according to claim 1, wherein the external power supply is a rechargeable battery.

11. A method of conditioning power by a power conditioner including a first converter that converts a first DC voltage supplied from an external power supply into a second DC voltage and an inverter that converts the second DC voltage into an AC voltage and outputs the AC voltage to an external line, the method comprising:
operating the inverter so as to keep receiving power in a predetermined range, the receiving power being received by the external line from a supply source system; and
stopping operations of the first converter and the inverter at predetermined time, the predetermined time being previously determined based on a magnitude of load power consumed by a load connected to the external line.

12. A method of conditioning power for a power conditioner including a first converter that converts a first DC voltage supplied from an external power supply into a second DC voltage and an inverter that converts the second DC voltage into an AC voltage and outputs the AC voltage to an external line, the method comprising:
operating the inverter so as to keep receiving power in a predetermined range, the receiving power being received by the external line from a supply source system; and
stopping operations of the first converter and the inverter when load power consumed by a load connected to the external line falls below a predetermined threshold.

13. The method according to claim 12, wherein the load power is calculated based on conditioning power output from the inverter and the receiving power.

14. The method according to claim 11, wherein
the first converter includes a first switching circuit and a first controller,
the inverter includes a second switching circuit and a second controller, and
the operations of the first converter and the inverter are stopped by interrupting supply of an operating voltage to the first controller and the second controller.

15. The method according to claim 11, wherein in response to an activation request from a device composing the load while the operation of the first converter and the inverter are stopped, the first converter and the inverter are activated while an activation notice is transmitted to the device.

16. The method according to claim 11, wherein
the power conditioner further comprises a second converter that converts a third DC voltage into the second DC voltage and outputs the second DC voltage to the inverter, the third DC voltage being supplied from a power generation apparatus using natural energy, and
in stopping the operations of the first converter and the inverter, an operation of the second converter is also stopped.

17. The method according to claim 16, wherein the power generation apparatus using the natural energy is a power generation apparatus using a solar panel.

18. The method according to claim 16, wherein
the second converter includes a third switching circuit and a third controller, and
an operation of the third is stopped by interrupting supply of an operating voltage to the third controller.

19. The method according to claim 11, wherein a receiving current supplied from the supply source system is measured, and a value of the receiving power is calculated from a measurement value of the receiving current.

20. The method according to claim 11, wherein the external power supply is a rechargeable battery.
